(19) United States
(12) Patent Application Publication
(10) Pub. No.: US 2005/0025670 A1
(43) Pub. Date: Feb. 3, 2005

(54) Diagnostic device and method of using same

(76) Inventors: Jerome L. Sinsky, (US); Christopher J. Gyben, (US)

Correspondence Address: JERRY RICHARD POTTS, 3248 VIA RIBERA, ESCONDIDO, CA, 92029, US

(21) Appl. No.: 10/934,805

(22) Filed: Sep. 3, 2004

Related U.S. Application Data
(63) Continuation of application No. 10/244,133, filed on Sep. 14, 2002.

(51) Int. Cl. G01N 31/22

(52) U.S. Cl. 422/58

(57) ABSTRACT

A diagnostic device for use in performing clinical tests on a fluid, including a light transmitting plate and a panel adhered to and substantially covering the plate. The panel has an opening therein formed and a strip of pH testing material, substantially smaller than the panel, is fixed between the plate and the panel to fill substantially the opening, wherein the pH testing material produces a color indicative of fluid pH upon contact with the fluid. A window formed in the panel exposes a portion of the plate wherein the panel forms a wall on the perimeter of the window to confine fluid applied to the plate, within an area defined by the window.

### BACKGROUND OF THE INVENTION

The present invention relates generally to clinical diagnostic testing devices and, more particularly, to such devices as utilized by physicians in their offices.

It is recognized that in the case of many pathological conditions, early identification and treatment can substantially reduce subsequent patient suffering. In this regard, testing of female vaginal samples has become recognized as important to the health of a patient.

The problem of vaginitis is one of the most common complaints bringing patients to physician's offices or clinics. The diagnosis is made after examination of vaginal fluid and testing of fluid pH, and a microscopic examination of the fluid.

In order for the test be competently performed, the pH of the fluid should be measured. Changes in pH can be, visually observed. For example, a vaginal pH sampler, having pH paper mounted at the end of a plastic stick can be used to sample the vagina directly. While the stick has some utility, it presents a waste management problem after use, as the clinician attempts to dispose of it. In addition, the stick is limited in use solely for pH detection.

“Wet mount” tests follow as microscopic examination follows pH determination. The fluid is treated with potassium hydroxide (KOH) and the fluid/reagent mix is examined under the microscope for the presence of yeast cells or hyphae.

A fluid sample is also treated with saline solution and microscopically examined for the possible presence of clue cells (epithelial cells obscured by an overgrowth of bacterial cells), white blood cells and, among other things, motile organisms, spores and trichomonads.

The combination of pH determination plus the KOH and saline microscopic examination is the most widely accepted and clinically used method in determining the cause of vaginitis.

At the present time, there is a lack of inexpensive, convenient techniques for supporting performance of the diagnostic steps. The use of the pH stick, and the need to dispose of after use has been mentioned. Performance of the wet mount tests complicates the matter since handling of fluid and reagents of samples for microscopic examination can be cumbersome. It can involve, for example, tearing off a piece of pH paper from a roll and wetting it with a vaginal sample. It may also involve the use of a separate container or vial, for transporting the sample to a laboratory either in an office or at a clinic for microscopic examination. Drops of the sample are then placed on two sites of a microscope slide. In some cases, a wax line is drawn down the center of a diagnostic device in an attempt to keep the saline treated fluid separate from the KOH treated fluid during the microscopic examination. At other times, two separate microscope slides are used to avoid mixing the two solutions. After microscopic examination, of course, the waste management problem is presented once again as disposal of wet slides, pH paper, pH sticks and transport containers or vials becomes necessary.

The above-mentioned conventional techniques are awkward to perform, time consuming and can present a problem in disposal of wet materials, possibly carrying pathogens. Accordingly, there has been a need for a diagnostic technique that provides a quick, relatively inexpensive and reliable way to perform the three tests on vaginal fluid samples in a more convenient, economical fashion. Desirably, such a technique would help ameliorate the waste disposal and handling problems. Many clinicians, therefore, skip one or more of these diagnostic steps and try to rely on guesswork to make a diagnosis here and this has been shown in studies to result in diagnostic and treatment errors.

### DISCLOSURE OF THE INVENTION

In a preferred embodiment, the invention provides a diagnostic device for use in performing clinical tests on a fluid, including a light transmitting plate and a panel adhered to and substantially covering the plate. The panel has an opening therein formed and a strip of pH testing material, substantially smaller than the panel, is fixed between the plate and the panel to fill substantially the opening, wherein the pH testing material produces a color indicative of fluid pH upon contact with the fluid. A window formed in the panel exposes a portion of the plate wherein the panel forms a wall on the perimeter of the window to confine fluid applied to the plate, within an area defined by the window.

A diagnostic device embodying the invention is easy and convenient to use and mechanically simple. It enables the grouping of components in a relatively small, easily reached countertop area and helps improve safe waste management by reducing the number of contaminated implements requiring disposal.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 is an isometric view of a preferred embodiment of a diagnostic device that is constructed according to the present invention; and

FIG. 2 is a plan view of the diagnostic device shown in FIG. 1.

### BEST MODE FOR CARRYING OUT THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

In the following detailed description and in the several figures of the drawings, like elements are identified with like reference numerals.

As shown in the drawings for purposes of illustration, the invention is embodied in a novel diagnostic device for enabling effective and efficient real time diagnosis of a medical condition. The diagnosis comprises both gross examination and microscopic examination of a bodily fluid by means of a device that is simple and convenient to use and, as one piece, is relatively safer from a waste management viewpoint.

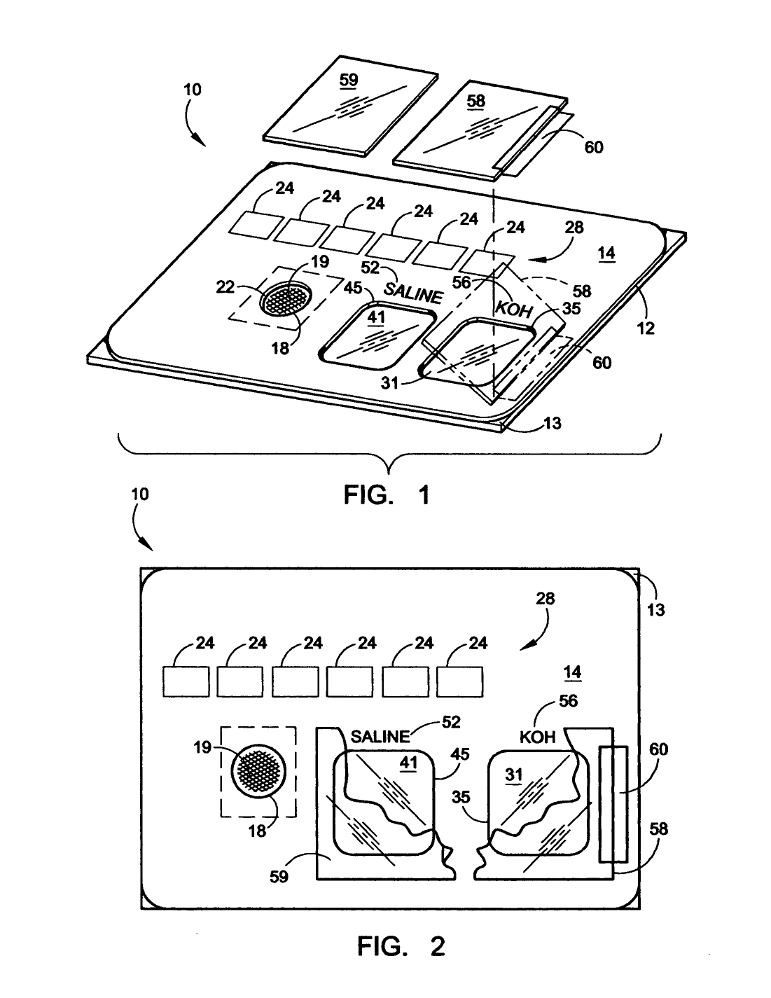

Referring now to the drawings, and in particular to FIGS. 1 and 2, there is shown a diagnostic device 10 that is constructed according to the present invention. The diagnostic device 10 is a disposable device that enables a clinician to perform a series of tests on vaginal fluid samples in a more convenient, economical fashion as will be explained hereinafter in greater detail. Moreover, since the diagnostic device 10 is disposable it helps ameliorate waste disposal and handling problems associated with other testing devices.

Considering now the diagnostic device 10 in greater detail with reference to FIGS. 1-2, the diagnostic device 10 is formed from a generally rectangular, light transmitting blank, or plate 12. The plate 12 is generally about 2 inches in height and about 3 inches in width and thus, is very easily handled.

As best seen in FIG. 1, the plate 12 is substantially covered by a stiff paper or cardboard panel 14 that adheres to an upper surface 13 of the plate 12. In the upper half of the panel 14 there is disposed a color gradient chart, generally referred to by the reference numeral 28. The color gradient chart 28 provides a series of color indicators 24, where colors across the gradient are indicative of pH indicators of about pH 3.0 to about pH 5.5. This color gradient arrangement, allows a clinician to conduct a simple visual matching, without the need of resorting to any other charts or tools for determining the pH level of a sampled fluid as will be explained hereinafter in greater detail.

A pair of adjacent cutouts or windows 31 and 41 respectively, is disposed in the panel 14 in its lower right quadrant. Another cutout or opening 18 is also disposed in a lower left quadrant of the panel 14. A strip of pH testing material, here in the form of pH indicator paper 19, is fixed between the plate 12 and the panel 14 to fill substantially the opening 18. The panel 14 is sufficiently thick to form a step or a wall 22 circumscribing the opening 18. The wall 22 helps confine any fluid placed in the opening 19. As in the case of the opening 18, the windows 31 and 41 are circumscribed by steps or wals 35 and 45, respectively, that serve to retain fluids within the respective areas therein defined. In this manner, after examination is completed, effective elimination of possibly contaminated fluid can be accomplished.

To help facilitate retaining any vaginal fluids deposited in the window areas 31 and 41, the diagnostic device 10 includes a pair of cover slips, such as the cover slips 58 and 59 respectively. The cover slips are adapted to be attached to the top surface of the panel 14 by a flexible adhesive hinge, such as the hinge 60. In this manner, after a vaginal fluid sample has been deposited into either window area, the slip cover can be attached to the plate 14 as indicated allowing the cover to close the fluid receiving area of the window. In the preferred embodiment of the present invention, the slip covers 58 and 59 are separated from the panel 14. It will be understood however, by those skilled in the art, that the slip covers could also be initially attached by their respective hinges, such as the hinge 60, rather than be separated.

Considering now the method of using the diagnostic device 10 for testing vaginal fluids, the clinician in testing for fluid pH, first places a drop of fluid (not shown) onto the pH indicator paper 19 and observes any color change in the paper. The resultant color is indicative of the fluid pH and this can be determined readily by reference to the colored chart 28. Thus, by simple visual matching, and without need to resort to other tools or separate reference color charts, the clinician can determine the pH of the fluid.

As set forth above, microscopic analysis is appropriate, along with a determination of fluid pH. Such analysis is facilitated by use of the windows 31 and 41 formed in the label 14. As in the case of the opening 18, the windows are circumscribed by steps or walls 35 and 45, respectively, that serve to retain fluids within the respective areas therein defined.

In use of the diagnostic device 10, microscopic examination of both the KOH and saline preparations are preferred. In this regard, upon determination of the type of microscopic examination desired, the clinician chooses the KOH window 31 and then after examination the saline window 41. As best seen in FIG. 2, indicia 52, located adjacent the window 41, displays the word “Saline” to prompt the clinician to add this solution to fluid previously placed on the window 41. In a similar manner, indicia 56, located adjacent the window 31, prompts the clinician to add potassium hydroxide (KOH) to the fluid on the window 31.

After the suitable reagents have been added to the fluids in the windows 31 and 41, cover slips 58 and 59, respectively, cover the windows for the microscopic examination. One skilled in the art will recognize at this step of the diagnostic process that subsequent disposal of the diagnostic device 10 and its contents is simplified by having all the reactants compartmentalized on the single plate 10.

It will be evident that there are additional embodiments and applications that are not disclosed in the detailed description but which clearly fall within the scope of the present invention. The specification is, therefore, intended not to be limiting, and the scope of the invention is to be limited only by the following claims.

1. A diagnostic device for use in performing clinical tests on a fluid, comprising:
a light transmitting plate having a top surface and a bottom surface; and
a panel adhered to only the top surface of said plate, said panel having at least one opening therein for defining a fluid retaining well on said plate.

2. (Cancelled)

3. The diagnostic device according to claim 1, further comprising:
a strip of litmus paper secured within said fluid retaining well for producing a color indicative of fluid pH upon contact with fluid.

4. (Cancelled)

5. The diagnostic device according to claim 1, wherein said panel carries indicia for correlating a color reaction in said strip of litmus paper with a fluid pH.

6. A diagnostic device for use in testing of vaginal fluid, comprising:
a light transmitting plate having a top surface and a bottom surface;
a panel having a window disposed therein, said panel being secured to only the top surface of said plate for defining a fluid retaining well at said window;
a strip of pH testing material, disposed within on said plate said fluid retaining well; and
wherein said strip of pH testing material produces a color indicative of fluid pH upon contact with fluid.

7. (Cancelled)

8. The diagnostic device according to claim 6, wherein said panel includes at least a pair of windows.

9. (Cancelled) The diagnostic device according to claim 6, wherein said strip of pH testing material is litmus paper.

10. The diagnostic device according to claim 6, including indicia on said panel for correlating a color reaction in said strip with a fluid pH.

11. The diagnostic device according to claim 6, including a cover slip for covering said window.

12. (Cancelled)

13. The diagnostic device according to claim 6, wherein the device is disposable.

14-27. (Cancelled)

28. A disposable device for facilitating the diagnosis of vaginitis, comprising:
a transparent plate for passing light;
a panel affixed to only one surface of said plate, said panel having a pH color gradient chart disposed thereon; and
a plurality of vaginal fluid test areas defined by cutouts in said panel, wherein at least one of said test areas has disposed therein a strip of litmus paper for reacting with a vaginal fluid sample so that a visual comparison of the pH level of the vaginal fluid sample and said pH color gradient chart can be performed.

29. A disposable device according to claim 28, wherein:
wherein at least two of said vaginal fluid test areas are transparent window areas allowing sufficient light to pass therethrough to conduct microscopic examination of said vaginal fluid sample when said sample reacts with different kinds of testing fluids.

30. A disposable device according to claim 29, wherein the different kinds of testing fluids include a saline solution and a potassium hydroxide solution.
